(19) United States
(12) Patent Application Publication
(10) Pub. No.: US 2007/0199037 A1
(43) Pub. Date: Aug. 23, 2007

(54) Broadcast program content retrieving and distributing system

(76) Inventors: Kazuhiro Matsuzaki, Tokyo (JP); Toyokazu Sugai, Tokyo (JP); Fuminobu Ogawa, Tokyo (JP)

Correspondence Address: BIRCH STEWART KOLASCH & BIRCH, PO BOX 747, FALLS CHURCH, VA, 22040-0747, US

(21) Appl. No.: 10/591,901

(22) PCT Filed: May 14, 2004
(86) PCT No.: PCT/JP04/06856

§ 371 Date: Sep. 7, 2006

(51) Int. Cl. H04N 7/173; H04N 7/16

(52) U.S. Cl. 725/115; 725/145; 725/100; 725/131

(57) ABSTRACT

A program content managing/providing system, a program content analyzing/retrieving system, and a user terminal are connected to each other via a network. When broadcasting a program content that is not stored, the program content managing/providing system stores the program content. In response to a distribution request of a desired program content from the user terminal, the program content managing/providing system distributes, to the user terminal, a stored program content corresponding to program information included in the distribution request. The program content analyzing/retrieving system receives and analyzes a broadcast program content and then extracts and saves the program information for each of the program contents. In response to a retrieval request of the program information of a desired program content from the user terminal, the program content analyzing/retrieving system provides, to the user terminal, stored program information of a program content that meets the retrieval request.

### TECHNICAL FIELD

The present invention relates to a broadcast program content retrieving and distributing system in which a retrieval service and a distribution service of a latest program content can be provided by receiving an on-air program and extracting program information at desired timing, and further a retrieval service and a distribution service of only a specific scene or a specific medium in a program can be provided.

### BACKGROUND ART

In the conventional broadcast program content retrieving and distributing systems, a user uses the Internet to search for a desired program content by inputting the title of the program content or the like in a retrieval system on a website of a broadcast program content retrieval service provider, to access the desired program content at the end after sequentially following genre categories, or to access the desired program content by searching a website of a program content provider.

Further, in the conventional broadcast program content retrieving and distributing systems, a plurality of distribution servers each connected to a contents storage server and a plurality of search servers each connected to a search database are connected to the Internet. When the user accesses a search server through the Internet to search for a program content, the titles of program contents that meet a search condition are extracted from the search database to be provided for the user. When the user specifies a desired one from the provided titles of program contents, the requested program content is distributed to the user through the distribution server connected to the contents storage server that stores the corresponding program content. Further, when a new program content is stored in a contents storage server, a system administrator inputs program information on the program content (see JP 2003-141167 A, for example).

In conventional broadcast program content retrieving and distributing services, a broadcaster or a related institution thereof generates a program database archive to provide program contents for users through the Internet. However, as in the case of Internet search services offered to general users, it is difficult for a plurality of search service providers to provide latest broadcast program contents for the general users by means of an elaborate and diversified search service.

With the conventional broadcast program content retrieving and distributing services, a search service is provided based on a keyword which is preset for each program, and thus has a problem in that it is difficult to provide a search service and a distribution service of a latest program content which is on the air or is obtained immediately after broadcast, and provide a search service and a distribution service of only a specific scene or a specific medium in a program.

Since a broadcaster serving as a program content provider has the copyright of a broadcast program content, it is difficult for a third-party provider other than the broadcaster to provide a search service of broadcast program contents.

The present invention has been made to solve the above-mentioned problems, and has an object to obtain a broadcast program content retrieving and distributing system in which a retrieval service and a distribution service of a latest program content which is on the air or is obtained immediately after broadcast, and a retrieval service and a distribution service of only a specific scene or a specific medium in a program can be provided, and elaborate search and distribution services can be provided.

### DISCLOSURE OF THE INVENTION

According to the present invention, there is provided a broadcast program content retrieving and distributing system, including: a program content managing/providing system for storing and managing program contents to be broadcasted and for providing a program broadcast service and a program content distribution service; a program content analyzing/retrieving system for analyzing a broadcasted program content to extract and store program information serving as a keyword for retrieval and for providing a program information retrieval service; and a user terminal, in which: the program content managing/providing system, the program content analyzing/retrieving system, and the user terminal are connected to each other through a network; the program content managing/providing system stores, in a case of broadcasting a non-stored program content, the non-stored program content, and distributes, in response to a distribution request of a desired program content sent from the user terminal, a stored program content corresponding to program information included in the distribution request, to the user terminal; and the program content analyzing/retrieving system receives and analyzes a broadcasted program content, extracts the program information to be stored on a program content basis, and provides stored program information on a program content which meets a search condition for the user terminal in response to a search request of program information on a desired program content sent from the user terminal.

### BRIEF DESCRIPTION OF THE DRAWINGS

FIG. 1 is a diagram showing a configuration of a broadcast program content retrieving and distributing system according to a first embodiment of the present invention;

FIG. 2 is a diagram showing a configuration of a program content database of the broadcast program content retrieving and distributing system according to the first embodiment of the present invention;

FIG. 3 is a diagram showing a configuration of a program content distribution request message of the broadcast program content retrieving and distributing system according to the first embodiment of the present invention;

FIG. 4 is a diagram showing a configuration of a program information database of the broadcast program content retrieving and distributing system according to the first and second embodiments of the present invention;

FIG. 5 is a diagram showing a screen display example of a user terminal in the broadcast program content retrieving and distributing system according to the first and second embodiments of the present invention;

FIG. 6 is a diagram showing a configuration of the broadcast program content retrieving and distributing system according to the second embodiment of the present invention; and

FIG. 7 is a diagram showing a configuration of a program content distribution request message of the broadcast program content retrieving and distributing system according to the second embodiment of the present invention.

### BEST MODE FOR CARRYING OUT THE INVENTION

Hereinafter, embodiments of the present invention will be described with reference to the drawings.

### First Embodiment

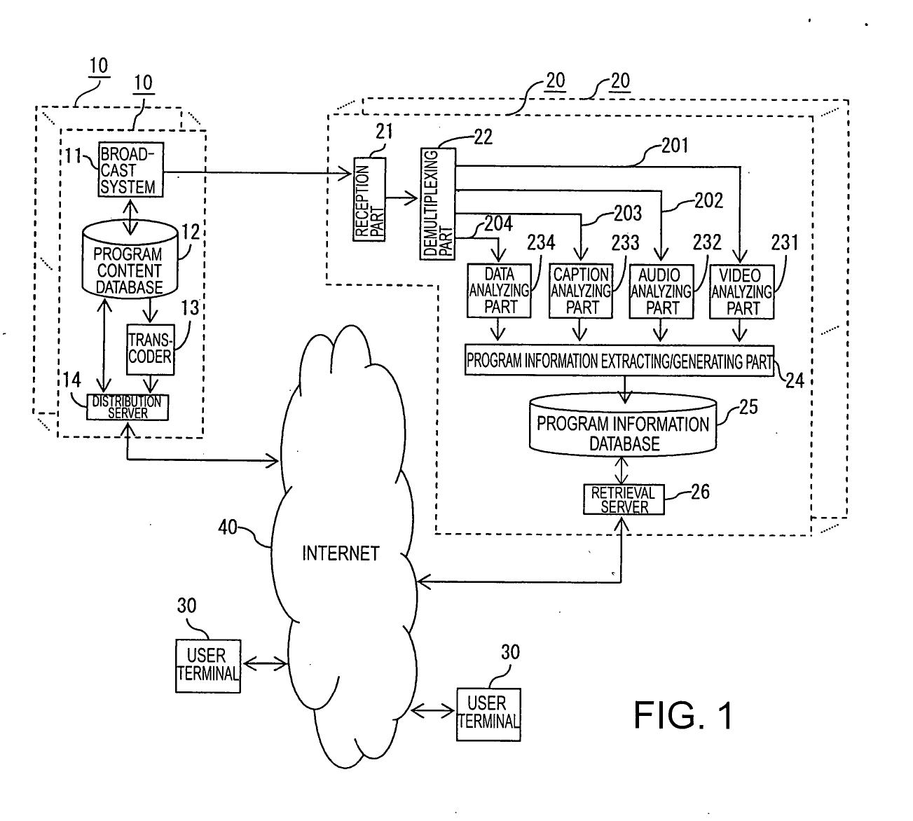

A broadcast program content retrieving and distributing system according to a first embodiment of the present invention will be described with reference to FIGS. 1 to 5. FIG. 1 is a diagram showing a configuration of the entire broadcast program content retrieving and distributing system according to the first embodiment of the present invention.

In FIG. 1, the broadcast program content retrieving and distributing system according to the first embodiment is provided with program content managing/providing systems 10 and program content analyzing/retrieving systems 20.

Each program content managing/providing system 10 stores and manages program contents to be broadcasted and provides a program broadcast service and a program content distribution service. Each program content analyzing/retrieving system 20 analyzes a program content, extracts therefrom program information to be used as a keyword for retrieval, and provides a program information retrieval service.

A plurality of program content managing/providing systems 10 and a plurality of program content analyzing/retrieving systems 20 are connected to the Internet 40 to provide the services for a plurality of user terminals 30.

The program content managing/providing system 10 includes: a broadcast system 11 for broadcasting a program; a program content database 12 for storing program contents; a transcoder 13 for performing signal conversion in terms of a resolution, encoding method, and multiplexing method of a program content; and a distribution server 14 for distributing a program content in response to a distribution request made by each user terminal 30.

The program content analyzing/retrieving system 20 includes: a reception part 21 for receiving a broadcasted program content; a demultiplexing part 22 for demultiplexing the received program content; an analyzing means 23 (this reference numeral is not shown) for analyzing a video coded bit string 201, an audio coded bit string 202, caption data 203, and other data 204; a program information extracting/generating part 24 for extracting or generating, based on a result of the analysis, program information such as a program title of a program content, a broadcast start time, a time length (broadcast date and time), a program genre, a cast, a program keyword, written work related information, a video format, and an encoding method; a program information database 25 for storing the program information; and a retrieval server 26 for retrieving the program information.

The analyzing means includes: a video analyzing part 231 for analyzing the video coded bit string 201; an audio analyzing part 232 for analyzing the audio coded bit string 202; a caption analyzing part 233 for analyzing the caption data 203; and a data analyzing part 234 for analyzing the other data 204.

Next, a description will be made of an operation of the broadcast program content retrieving and distributing system according to the first embodiment.

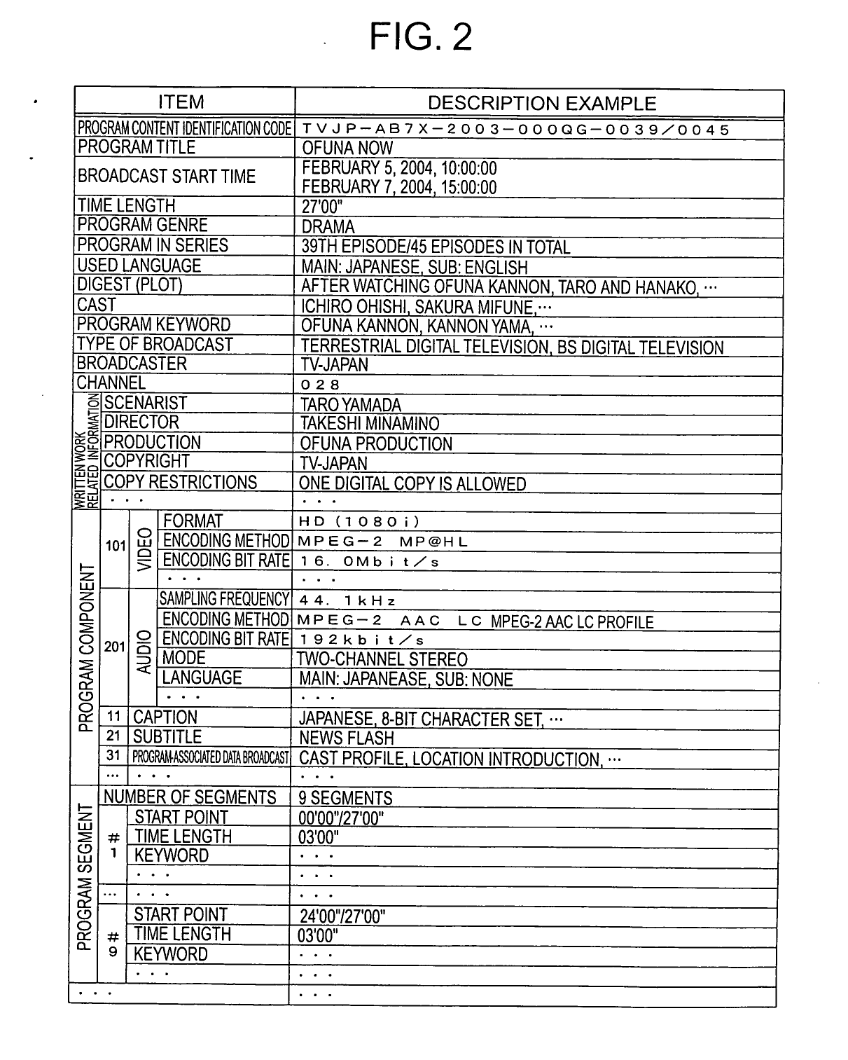

FIG. 2 is a diagram showing a configuration of metadata for each program content stored in the “program content database” of the broadcast program content retrieving and distributing system according to the first embodiment of the present invention. The program content itself is not shown.

In the program content managing/providing system 10, the broadcast system 11 broadcasts a program according to a broadcast schedule. The broadcast is carried out by using a program content stored in the program content database 12, or by using a program content not stored in the program content database 12 as in a case of a live program such as live broadcast. In the latter case, the broadcast system 11 assigns program content identification code to such a program content used for live broadcast and stores the program content in the program content database 12. Meanwhile, the distribution server 14 accepts a program content distribution request message from the user terminal 30.

The broadcast system 11 assigns metadata as shown in FIG. 2 to each program content and stores the program content in the program content database 12 in an MPEG-2 TS (transport Stream) format. Each piece of the metadata shown in FIG. 2 is not newly generated when the program content is stored, but is generated by using caption data provided for broadcasting a program content, basic information serving as a source of an electric program guide (EPG), metadata associated with server-type broadcast, and information provided by a data broadcast service. The program content identification code is used to identify the stored program content. When each program content is constituted by a plurality of program segments, the broadcast system 11 divides the program content into files corresponding to the program segments, assigns to each file a file name corresponding to each program segment number (for example, #1 or #9, as shown in FIG. 2), and stores and manages the files in the program content database 12. The broadcast system 11 assigns a program component identification number (for example, 101, 201, 11, 21, or 31, as shown in FIG. 2) to each program component, and stores and manages it in the program content database 12.

To a program component that is placed in a TS packet and multiplexed in the MPEG-2 TS format, such as video and audio, a value of PID included in the TS packet is assigned as a “program component identification number”. On the other hand, to a program component to which a unique PID cannot be assigned, such as a program component to be transmitted using an extension field of coded syntax of video or audio, assigned is a unique program component identification number that is outside the range of PID values and that is not the same as any of the program component identification numbers of the other program components.

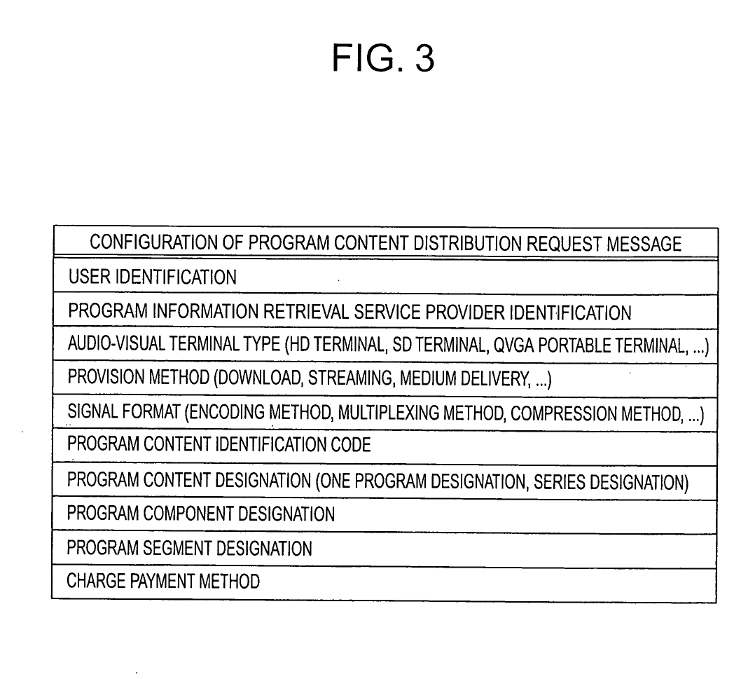

FIG. 3 is a diagram showing a configuration of the “program content distribution request message” of the broadcast program content retrieving and distributing system according to the first embodiment.

As shown in FIG. 3, the program content distribution request message includes: a “user identification” for identifying a user; a “program information retrieval service provider identification” for identifying a service provider used to retrieve program information on a program content; an “audio-visual terminal type” for identifying a terminal to be used by the user for watching a program; a “provision method” for indicating how to provide the program content; a “signal format” for indicating a signal format used to transmit the program content; “program content identification code” for identifying the program content desired to be distributed; “program content designation” for specifying whether distribution of one program corresponding to the program content identification code is desired or distribution of a series of programs corresponding to the program content identification codes is desired; “program component designation” for specifying, by the program component identification number, a component (a specific medium) such as video or audio that constitutes a program; “program segment designation” for specifying, by the program segment number, program distribution limited to a program segment (a specific scene) serving as a specified time segment in the program; and a “charge payment method” for indicating how to pay a program content distribution charge.

Referring to the program content distribution request message, the distribution server 14 reads a program content requested by the user terminal 30, from the program content database 12 by using the program content identification code. After the transcoder 13 performs signal conversion according to the type of an audio-visual terminal specified in the program content distribution request message, the distribution server 14 provides the program content according to the provision method specified by the user.

When a distribution request of one or more program segments of a program content is made from the user terminal 30, the distribution server 14 reads the corresponding program segment(s) of the program content sequentially from the program content database 12 by using the program segment number(s), and provides the program content according to the provision method specified by the user terminal 30.

Further, when a distribution request is made by the user terminal 30 on a program component basis, such as video, audio, caption, electric program guide information, and other metadata that constitute a program content, the distribution server 14 can provide the requested program component for the user terminal 30 by referring to identification information (“PID”, “table id”, or the like) of the corresponding program component because the program contents are managed in the MPEG-2 TS format in the program content database 12.

In addition to executing the signal conversion of a program content according to the type of an audio-visual terminal specified in the program content distribution request message as described above, the transcoder 13 provides a preview service and a digest view service for checking the content of a desired program content when the user uses the user terminal 30 to obtain the program content from the program content managing/providing system 10. Program contents to be provided by those view services are not allowed to be copied (i.e., cannot be recorded) by copy control. Further, to avoid abuse of a program content, the transcoder 13 may provide a lower-quality version of the program content generated by transcoding.

In the program content analyzing/retrieving system 20, the reception part 21 receives a broadcasted program content from the broadcast system 11 of the program content managing/providing system 10 by using a broadcast wave or a dedicated line. Note that the distribution server 14 and the reception part 21 may be connected to each other with a dedicated line (not shown) to provide a program content according to an agreement between a provider having the program content managing/providing system 10 and a provider having the program content analyzing/retrieving system 20. Then, the received program content is divided by the demultiplexing part 22 into the video coded bit string 201, the audio coded bit string 202, the caption data 203, and the other data 204 (including basic information serving as a source of the electric program guide (EPG), metadata associated with server-type broadcast, and information provided by the data broadcast service). The signals obtained through the division are inputted to the video analyzing part 231, the audio analyzing part 232, the caption analyzing part 233, and the data analyzing part 234, respectively. Attribute information thereof, such as a program title, a broadcast start time (broadcast date and time), a program genre, a digest (plot), a cast, a program keyword associated with the program, a video format, an encoding method, and an encoding bit rate, is extracted and inputted to the program information extracting/generating part 24.

The video analyzing part 231 analyzes the video coded bit string 201, such as an MPEG-2 video coded bit string, an MPEG-4 video coded bit string, and an H.263 video coded bit string, and extracts attribute information associated with a video. Specifically, extracted is attribute information, such as a video format, an encoding method (coding profile), an encoding bit rate, and an encoding mode, which is set in a header area such as a sequence header area and a picture header area in the video coded bit string 201.

The audio analyzing part 232 analyzes the audio coded bit string 202, such as an MPEG-2 AAC (advanced audio coding) audio coded bit string and an MPEG-4 audio coded bit string, and extracts attribute information such as a sampling frequency, an encoding method, an encoding bit rate, an encoding mode (monaural, stereo, profile, or the like), and a language. Further, the audio analyzing part 232 decodes the audio coded bit string 202, extracts a keyword and information of a spoken time period of a specific cast by using a voice recognition technology or a speaker verification technology.

The caption analyzing part 233 refers to language code information in the caption data 203, obtained through demultiplexing, to identify the used language, applies syntax analysis to the caption data, and extracts information such as a keyword, names of characters, and appearance periods of time of respective characters.

The data analyzing part 234 analyzes the other data 204 including basic information serving as a source of the electric program guide (EPG), metadata associated with server-type broadcast, and information provided by the data broadcast service.

The basic information serving as a source of the electric program guide (EPG) is provided in the form of an MPEG-2 TS (transport stream) section format or various descriptors. The MPEG-2 TS (transport stream) section format or various descriptors are analyzed to extract the program title, the broadcast date and time (broadcast start time and time length), the program genre, the used language, the digest (plot), the program keyword, the type of broadcast (such as terrestrial digital television, satellite digital television, terrestrial digital sound, and satellite digital sound), the broadcaster name, the broadcast channel name, the broadcast target area, the medium information constituting the program, and the like. Information on the video format and part of information on the encoding mode that are extracted by the video analyzing part 231 and the audio analyzing part 232 can also be obtained from the basic information serving as a source of the electric program guide (EPG).

The metadata associated with server-type broadcast is written in the XML format, and multiplexed and transmitted in the form of MPEG-2 TS, based on the data-carousel transmission specifications defined by ISO/IEC 13818-6. This metadata is composed of: content description metadata which describes universal information (a program title, a program genre, a digest, and the like) related to a program content; instance description metadata which describes a specific instance (a location, rules on use, and the like); and segmentation metadata which describes information, such as a start point (start time), a time length (duration), a genre, and a free keyword, for each program segment corresponding to one of various features or a specific scene in the program. The data analyzing part 234 analyzes the metadata associated with server-type broadcast and extracts information on the entire program and information on each program segment.

In addition, the data analyzing part 234 analyzes and extracts information provided by the data broadcast service, such as a program-associated data broadcast which provides information related to the content of a program and an independent data broadcast which provides information independent of a program, for example, weather forecast and traffic information.

The program information extracting/generating part 24 eliminates duplication of various attribute information obtained by the video analyzing part 231, the audio analyzing part 232, the caption analyzing part 233, and the data analyzing part 234, and classifies the attribute information into information on each program, information on each program component (including weather forecast and traffic information which are not directly related to the content of a program), and information on each program segment. The program information extracting/generating part 24 associates a broadcast date and time, a cast, a keyword, medium information, and the like with each classified information, generates program information by assigning the program content identification code thereto, and stores the program information in the program information database 25.

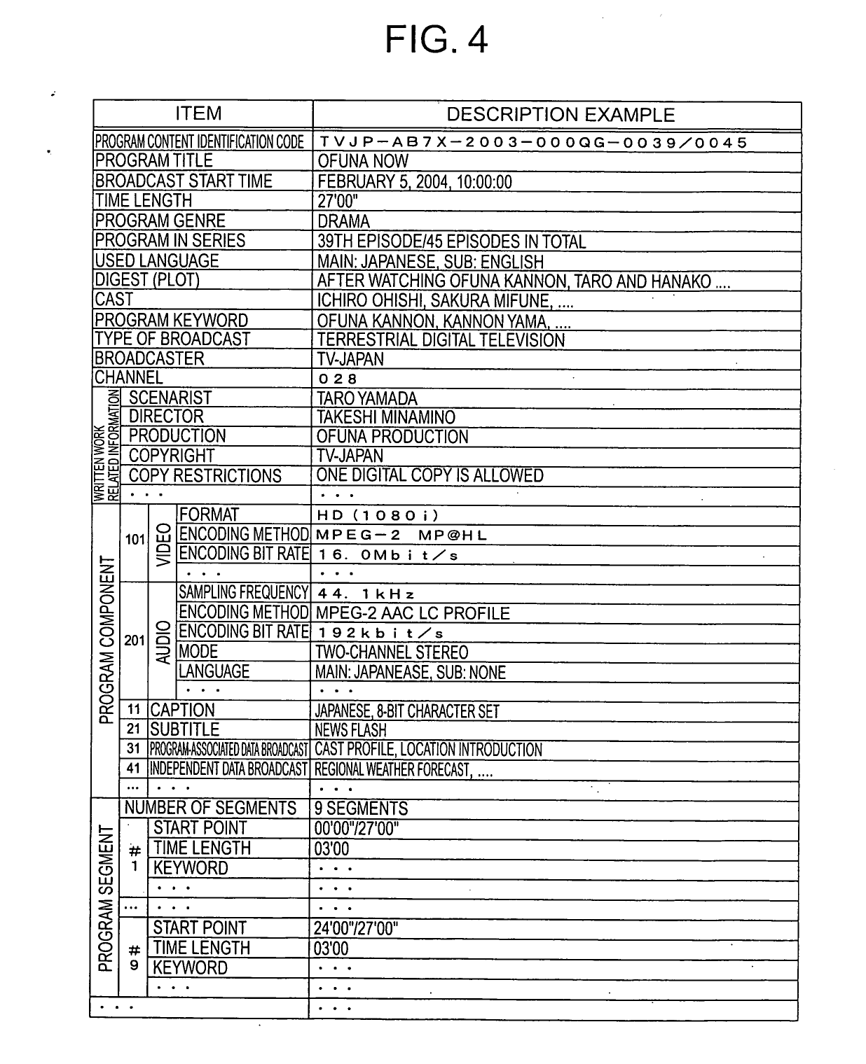

FIG. 4 is a diagram showing a configuration (content of program information on each program content) of the “program information database” of the broadcast program content retrieving and distributing system according to the first embodiment of the present invention.

As shown in FIG. 4, stored on a program content basis in the program information database 25 are: program-based information such as the program content identification code uniquely assigned to an individual program content, a program title, a program genre, a channel, and written work related information (a scenarist name, a director name, a production, a copyright, copy restrictions, and the like); program-component-based information on each program component such as video and audio; and program-segment-based information.

The user uses the user terminal 30 connected to the Internet 40 to access the retrieval server 26, performs a program title search, broadcast date and time search, cast search, keyword search, and the like, and obtains information necessary to make a program content distribution request, for example, information on a program, a program component, or a program segment, which meets a search condition.

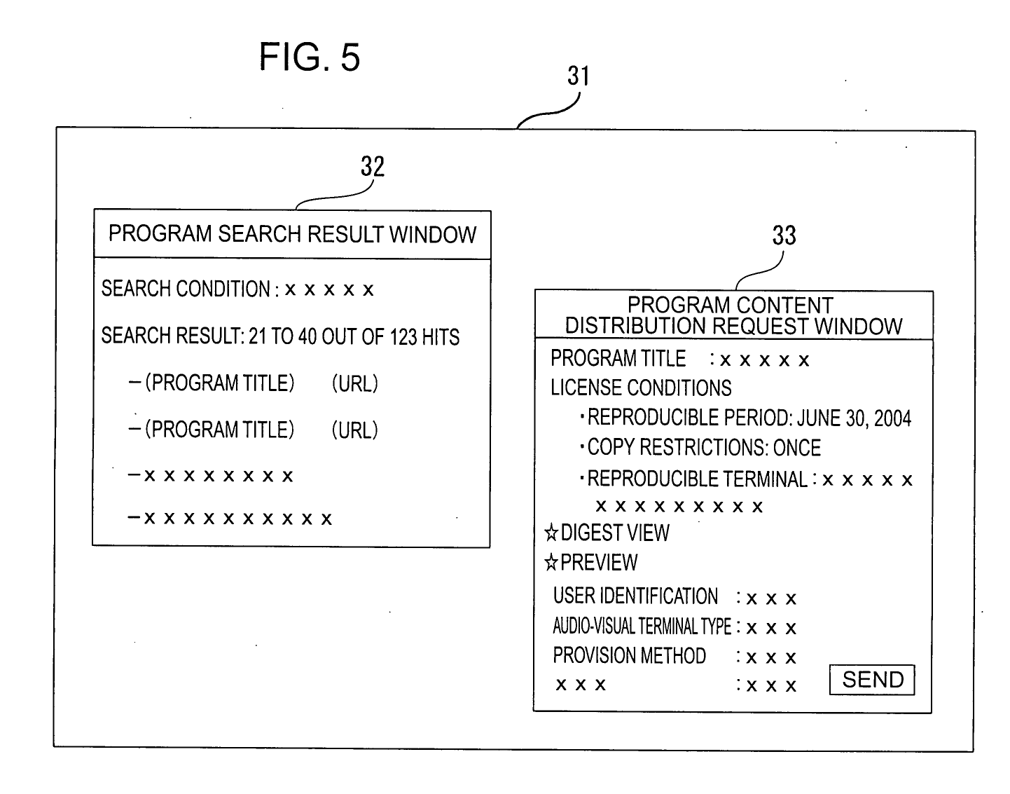

FIG. 5 is a diagram showing a screen display example of the user terminal in the broadcast program content retrieving and distributing system according to the first embodiment of the present invention.

For example, a program search result list obtained through the program title search is displayed in a program search result window 32 on a screen 31 of the user terminal 30. When an item of interest (for example, a program title) in the program search result window 32 is clicked, the URL of the program content managing/providing system 10 storing a corresponding program content is obtained to access the distribution server 14, whereby displaying a program content distribution request window 33. A URL of the program content managing/providing system 10 is obtained in advance by a provider having the program content analyzing/retrieving system 20 from the provider having the program content managing/providing system 10 and is set in the retrieval server 26.

In the program content distribution request window 33, in addition to the program title, license conditions (a reproducible period, copy restrictions, a reproducible terminal, charging information, and the like), a selection menu of the digest view service and the preview service for checking the content of a program content, and items (such as a user identification, a user terminal identification, and a provision method) to be inputted by a user in the program content distribution request message, and the like are displayed to provide the preview service or the digest view service for the program content and to automatically generate the program content distribution request message. The reproducible period and the copy restrictions are based on the “written work related information” in the program content database 12 of FIG. 2. Further, since the reproducible terminal is determined by a function of the transcoder 13, information of the reproducible terminal is obtained in advance.

The user checks the content of a desired program content by using the preview service or the digest view service in the program content distribution request window 33, inputs data to items necessary to make a distribution request of the desired program content, and clicks a “send” button. When the “send” button is clicked, a program content distribution request message is automatically generated and sent to the distribution server 14.

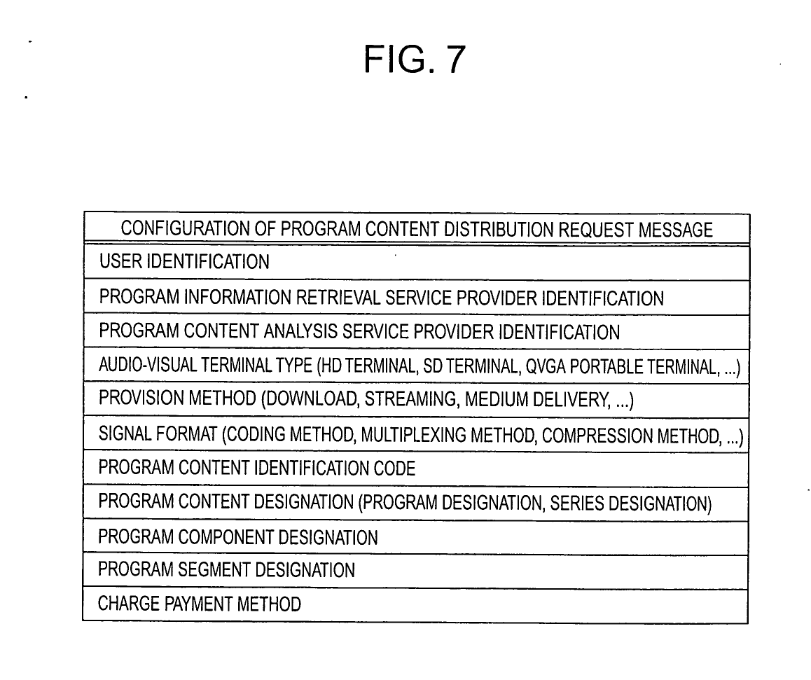

Among items in the program content distribution request message, data for the “program information retrieval service provider identification” and a “program content analysis service provider identification” (see FIG. 7) are given by the retrieval server 26, and therefore, the user need not input them. The user inputs data to each item of “user identification”, “audio-visual terminal type”, “provision method”, “signal format”, “program content identification code”, and “charge payment method” in the program content distribution request window 33. To the “user identification”, an e-mail address of the user terminal 30 or an address of the user is inputted, for example.

In a case of making a distribution request on a program basis, the user further inputs data to an item “program content designation” in the program content distribution request window 33. In this case, inputs to the “program component designation” and the “program segment designation” are not required.

Further, in a case of making a distribution request on a program component basis, the user further inputs a desired program component identification number to an item of the “program component designation” in the program content distribution request window 33. In this case, inputs to the “program content designation” and the “program segment designation” are not required.

Furthermore, in a case of making a distribution request on a program segment basis, the user further inputs a desired program segment number to an item of the “program segment designation” in the program content distribution request window 33. In this case, inputs to the “program content designation” and the “program component designation” are not required.

When program segments are set in the broadcast system 11 of the program content managing/providing system 10, the length of each program segment may be set to a fixed time length. With the length of a program segment being set to a fixed time length, extraction of a program segment and various settings of segmentation metadata become easier as compared to a case where the program segment is associated with one of various features or a specific scene in the program. When the length of a program segment is set to a fixed time length, video decoding is not started from the head of the program segment because the head video frame of the program segment is not always coded in an intra-mode, and thus the video decoding is started from a video frame which is coded in the intra-mode so as to reproduce the video properly.

As described above, the program content analyzing/retrieving system 20 extracts program information to be used for the program information retrieval service while receiving an on-air program content, so that the program information retrieval service of a latest program content obtained immediately after broadcast can be provided.

In addition, since a plurality of program content analyzing/retrieving systems 20 can be connected to the Internet 40, a plurality of providers each having the program content analyzing/retrieving system 20 can provide the program information retrieval service for general users through the Internet 40. Accordingly, retrieval services having various features can be provided, and the user can freely select and use a plurality of such program information retrieval services.

Further, since a program content is not provided by means of the program information retrieval service, the provider having the program content analyzing/retrieving system 20 can provide the program information retrieval service without infringing the copyright of the program content.

Further, a program content provider having the copyright of a program content can directly provide the program content for the user under the license conditions that meet the intention of the program content provider without going through a provider having the program content analyzing/retrieving system 20. Therefore, it is advantageous to avoid abuse of program contents.

Further, since program information to be stored in the program information database 25 is structured as shown in FIG. 4, a specific scene (a specific program segment) or a specific medium (a specific program component) in a program content, meeting a search condition can be retrieved. Accordingly, when the program content managing/providing system 10 has received a program content distribution request message from the user terminal 30, it can provide for the user a specific scene or a specific medium to which the distribution request is made, by referring to various information such as the program content identification code, the program content designation, the program component designation, and the program segment designation, which are specified in the message. Thus, the program content managing/providing system 10 can provide elaborate retrieval and distribution services.

Furthermore, the program information database 25 of the program content analyzing/retrieving system 20 stores program information such as a program title of each program content, broadcast date and time, a program genre, a digest (plot), a cast, a program keyword, a video format, an encoding method, and an encoding bit rate, and does not store a program content itself. Thus, the storage capacity of the program information database 25 can be dramatically reduced as compared with that of a database used in a case of providing a retrieval service while storing program contents.

On the other hand, in the program content managing/providing system 10, since the transcoder 13 performs signal conversion in terms of resolution, encoding method, and multiplexing method of a program content, a program content can be provided with a quality corresponding to the type of an audio-visual terminal of the user.

Further, in the program content managing/providing system 10, the preview service and the digest view service are provided to check the content of a desired program content when the user obtains the program content. Therefore, the user is prevented from erroneously making a distribution request of a different program content when a plurality of program contents meet a search condition.

Since the user sends a program content distribution request message to a provider having the program content managing/providing system 10 to make a distribution request of a program content, the provider having the program content managing/providing system 10 knows a provider whose program information retrieval service is used by the user to make the distribution request of a program content, by referring to the program information retrieval service provider identification in the program content distribution request message. Therefore, part of margin obtained due to the provision of the program content distribution service can be fed back to the program information retrieval service provider.

### Second Embodiment

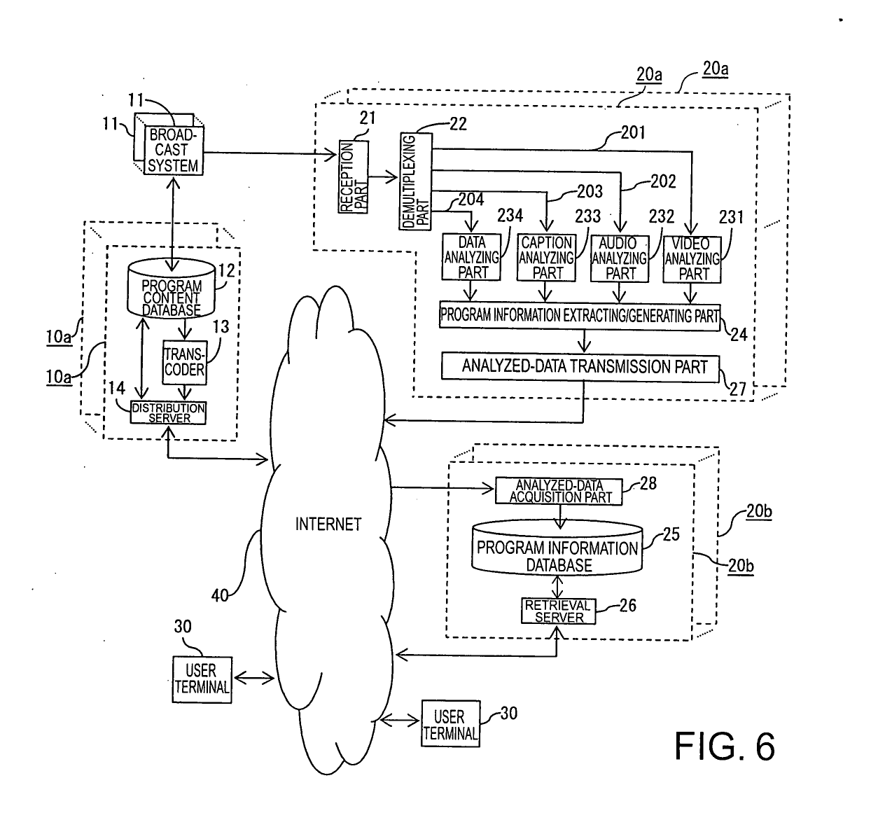

A description will be made of a broadcast program content retrieving and distributing system according to a second embodiment of the present invention with reference to FIGS. 6 and 7. FIG. 6 is a diagram showing a configuration of the broadcast program content retrieving and distributing system according to the second embodiment of the present invention.

According to the above-described first embodiment, the program content managing/providing system 10 provides the program broadcast service and provides the program content distribution service for the user in response to a distribution request. On the other hand, the program content analyzing/retrieving system 20 analyzes a received program content to extract various program information, stores the extracted various program information in the program information database 25, and provides the program information retrieval service of a broadcasted program content.

However, according to the second embodiment, the program broadcast service and the program content distribution service are provided by different systems. In addition, a program content analysis service for analyzing and extracting various program information on a program content and the program information retrieval service are provided by different systems.

In FIG. 6, the broadcast program content retrieving and distributing system according to the second embodiment is provided with the broadcast systems 11, a program content distribution system 10a, a program content analyzing system 20a, and a program information retrieval system 20b.

A plurality of program content distribution systems 10a, a plurality of program content analyzing systems 20a, and a plurality of program information retrieval systems 20b are connected to the Internet 40.

Each of the broadcast systems 11 is connected to one or more program content distribution systems 10a by a dedicated line, and provides the program broadcast service by using a program content stored in the program content database 12 or a program content provided by a live program.

Each program content distribution system 10a provides the distribution service of a program content to which a distribution request is made by the user terminal 30, and the preview service and the digest view service for checking the content of a program content. The user terminal 30 makes a program content distribution request by sending a program content distribution request message to the program content distribution system 10a, as in the first embodiment.

FIG. 7 is a diagram showing a configuration of the “program content distribution request message” of the broadcast program content retrieving and distributing system according to the second embodiment.

The program content distribution request message has the same structure as in the first embodiment, shown in FIG. 3, except that the “program content analysis service provider identification” is added.

In each program content analyzing system 20a, a program content is analyzed to extract various program information and the program information on each program content, as shown in FIG. 4, is transferred from an analyzed-data transmission part 27 to a program information retrieval system 20b through the Internet 40.

In each program information retrieval system 20b, an analyzed-data acquisition part 28 receives program information on each program content transferred from one or more program content analyzing systems 20a, the program information is stored in the program information database 25, and then the program information retrieval service for the program content is provided.

Processing of other parts are the same as those of the corresponding parts in the first embodiment.

As described above, according to the second embodiment, a function provided by each system is associated with any one of the program broadcast service, the program content distribution service, the program content analysis service, and the program information retrieval service, and the systems are connected to each other through a broadcast wave, a dedicated line, or the Internet 40. Therefore, each system can pull the functions together and have independency. Further, even when specifications of a certain system are changed, other systems are less influenced. Accordingly, each system has extensibility and can easily have a redundant configuration to cope with system troubles.

A provider having the program content analyzing system 20a provides the program content analysis service for a provider having the program information retrieval system 20b, the provider having the program information retrieval system 20b provides the program information retrieval service for general users, and a provider having the program content distribution system 10a provides the program content distribution service for the general users. Therefore, the providers can provide the services in cooperation with each other while maintaining independence among them.

### INDUSTRIAL APPLICABILITY

As described above, the broadcast program content retrieving and distributing system according to the present invention includes: a program content managing/providing system for storing and managing program contents to be broadcasted and for providing a program broadcast service and a program content distribution service; a program content analyzing/retrieving system for analyzing a broadcasted program content to extract and store program information serving as a keyword for retrieval and for providing a program information retrieval service; and a user terminal, in which: the program content managing/providing system, the program content analyzing/retrieving system, and the user terminal are connected to each other through a network; the program content managing/providing system stores, in a case of broadcasting a non-stored program content, the non-stored program content, and distributes, in response to a distribution request of a desired program content sent from the user terminal, a stored program content corresponding to program information included in the distribution request, to the user terminal; and the program content analyzing/retrieving system receives and analyzes a broadcasted program content, extracts the program information to be stored on a program content basis, and provides stored program information on a program content which meets a search condition for the user terminal in response to a search request of program information on a desired program content sent from the user terminal. Therefore, the broadcast program content retrieving and distributing system allows a retrieval service and a distribution service of a latest program content which is on the air or is obtained immediately after broadcast, and elaborate search and distribution services.

1. A broadcast program content retrieving and distributing system, comprising:
a program content managing/providing system for storing and managing program contents to be broadcasted and for providing a program broadcast service and a program content distribution service;
a program content analyzing/retrieving system for analyzing a broadcasted program content to extract and store program information serving as a keyword for retrieval and for providing a program information retrieval service; and
a user terminal, wherein:
the program content managing/providing system, the program content analyzing/retrieving system, and the user terminal are connected to each other through a network;
the program content managing/providing system stores, in a case of broadcasting a non-stored program content, the non-stored program content, and distributes, in response to a distribution request of a desired program content sent from the user terminal, a stored program content corresponding to program information included in the distribution request, to the user terminal; and
the program content analyzing/retrieving system receives and analyzes a broadcasted program content, extracts the program information to be stored on a program content basis, and provides stored program information on a program content which meets a search condition for the user terminal in response to a search request of program information on a desired program content sent from the user terminal.

2. The broadcast program content retrieving and distributing system according to claim 1,
wherein the program content managing/providing system comprises:
a program content database for storing program contents;
a broadcast system for broadcasting a program content stored in the program content database and for storing, in a case of broadcasting a program content which does not exist in the program content database, the non-existing program content in the program content database;
a transcoder for performing signal conversion of a program content which is read from the program content database based on the distribution request; and
a distribution server for reading, from the program content database, a program content corresponding to program information included in the distribution request, in response to the distribution request, and for distributing the program content to the user terminal.

3. The broadcast program content retrieving and distributing system according to claim 1,
wherein the program content analyzing/retrieving system comprises:
a program information database for storing program information on a program content basis;
a reception part for receiving a broadcasted program content;
a demultiplexing part for demultiplexing the received program content;
an analyzing means for analyzing the demultiplexed program content;
a program information extracting/generating part for extracting/generating program information on the program content based on an analysis result of the analyzing means, and for storing the program information in the program information database on a program content basis; and
a retrieval server for reading, from the program information database, program information on a program content which meets a search condition, in response to a search request of program information on a desired program content from the user terminal, and for providing the program information for the user terminal.

4. The broadcast program content retrieving and distributing system according to claim 3,
wherein the analyzing means comprises:
a video analyzing part for analyzing a video coded bit string obtained through demultiplexing of the demultiplexing part;
an audio analyzing part for analyzing an audio coded bit string obtained through demultiplexing of the demultiplexing part;
a caption analyzing part for analyzing caption data obtained through demultiplexing of the demultiplexing part; and
a data analyzing part for analyzing other data obtained through demultiplexing of the demultiplexing part.

5. The broadcast program content retrieving and distributing system according to claim 1,
wherein the program content managing/providing system comprises:
a broadcast system for broadcasting a stored program content, and for storing, in a case of broadcasting a non-stored program content, the non-stored program content; and
a program content distribution system for providing, in response to a distribution request of a desired program content from the user terminal, a stored program content corresponding to program information included in the distribution request, for the user terminal.

6. The broadcast program content retrieving and distributing system according to claim 5,
wherein the program content distribution system comprises:
a program content database for storing program contents;
a transcoder for performing signal conversion of a program content which is read from the program content database based on the distribution request; and
a distribution server for reading, from the program content database, a program content corresponding to program information included in the distribution request, in response to the distribution request, and for distributing the program content to the user terminal.

7. The broadcast program content retrieving and distributing system according to claim 1,
wherein the program content analyzing/retrieving system comprises:
a program content analyzing system for receiving and analyzing a broadcasted program content, and for extracting/generating the program information to be transmitted; and
a program information retrieval system for storing the obtained program information on a program content basis, and for providing stored program information on a program content which meets a search condition for the user terminal in response to a search request of program information on a desired program content from the user terminal.

8. The broadcast program content retrieving and distributing system according to claim 7,
wherein the program content analyzing system comprises:
a reception part for receiving a broadcasted program content;
a demultiplexing part for demultiplexing the received program content;
an analyzing means for analyzing the demultiplexed program content;
a program information extracting/generating part for extracting/generating program information on the program content based on an analysis result of the analyzing means; and
an analyzed-data transmission part for transmitting the extracted/generated program information to the network.

9. The broadcast program content retrieving and distributing system according to claim 8,
wherein the analyzing means comprises:
a video analyzing part for analyzing a video coded bit string obtained through demultiplexing of the demultiplexing part;
an audio analyzing part for analyzing an audio coded bit string obtained through demultiplexing of the demultiplexing part;
a caption analyzing part for analyzing caption data obtained through demultiplexing of the demultiplexing part; and
a data analyzing part for analyzing other data obtained through demultiplexing of the demultiplexing part.

10. The broadcast program content retrieving and distributing system according to claim 7,
wherein the program information retrieval system comprises:
a program information database for storing program information on a program content basis;
an analyzed-data acquisition part for acquiring program information from the network and for storing the program information in the program information database; and
a retrieval server for reading, from the program information database, program information on a program content which meets a search condition, in response to a search request of program information on a desired program content from the user terminal, and for providing the program information for the user terminal.

11. The broadcast program content retrieving and distributing system according to claim 1, wherein:
when a program content is constituted by a plurality of program segments, the program content managing/providing system stores and manages the program content by assigning identification information to each of the program segments, and distributes, in response to a program-segment-based distribution request of a desired program content sent from the user terminal, a program segment of a stored program content corresponding to program-segment-based identification information included in the distribution request, to the user terminal; and
the program content analyzing/retrieving system receives and analyzes a broadcasted program content, extracts the program-segment-based identification information to be stored on a program content basis, and provides for the user terminal, stored program-segment-based identification information on a program content which meets a search condition, in response to a search request of program-segment-based program information on a desired program content, sent from the user terminal.

12. The broadcast program content retrieving and distributing system according to claim 1, wherein:
when a program content is constituted by a plurality of program components, the program content managing/providing system stores and manages the program content by assigning identification information to each of the program components, and distributes, in response to a program-component-based distribution request of a desired program content sent from the user terminal, a program component of a stored program content corresponding to program-component-based identification information included in the distribution request, to the user terminal; and
the program content analyzing/retrieving system receives and analyzes a broadcasted program content, extracts the program-component-based identification information to be stored on a program content basis, and provides for the user terminal, stored program-component-based identification information on a program content which meets a search condition, in response to a search request of program-component-based program information on a desired program content, sent from the user terminal.

13. The broadcast program content retrieving and distributing system according to claim 1, wherein:
a plurality of the program content managing/providing systems and a plurality of the program content analyzing/retrieving systems are connected to each other through the network;
the program content analyzing/retrieving system provides for the user terminal, in response to a search request of program information on a desired program content sent from the user terminal, a service provider identification together with stored program information on a program content which meets a search condition; and
the user terminal includes the service provider identification in a distribution request of the desired program content to be sent to the program content managing/providing system.
